(19) United States
(12) Patent Application Publication
(10) Pub. No.: US 2024/0259374 A1
(43) Pub. Date: Aug. 1, 2024

(54) SYSTEM FOR DYNAMIC NETWORK SECURITY CONTROL

(71) Applicant: Salesforce, Inc., San Francisco, CA (US)

(72) Inventors: Anmol Arora, Surrey (CA); Chaitanya Pemmaraju, San Francisco, CA (US); Nagaraja Shenoy, Bengaluru (IN)

(21) Appl. No.: 18/138,957

(22) Filed: Apr. 25, 2023

(30) Foreign Application Priority Data
Jan. 31, 2023 (IN) 202341006351

(51) Int. Cl. H04L 9/40; H04L 61/2521

(52) U.S. Cl. CPC H04L 63/10; H04L 61/2532; H04L 63/20; H04L 2101/60

(57) ABSTRACT

A method or system for dynamic network security control. The system discovers multiple external network addresses (ENAs) associated with multiple services in a trusted public cloud environment (TPCE), and records the discovered ENAs in a first storage. The system also accesses multiple network security policies stored in the TPCE. The system then maps the ENAs to the network security policies based on contextual relationships therebetween, and stores mappings between the ENAs and the network security policies in the TPCE. The system causes a network access control list to be update based in part on the mappings. The network access control list contains rules that specify which entities are granted or denied access to the ENAs associated with the services.

### RELATED APPLICATION

This application claims the right of priority based on India Provisional Patent Application Serial No. 202341006351, entitled “System for Dynamic Network Security Control”, filed Jan. 31, 2023, which is incorporated by reference in its entirety.

### BACKGROUND

### Field of Art

This disclosure generally relates to network security control, and in particular, to dynamic network security control in trusted public cloud environments (TPCEs) based on relationships between external network addresses (ENAs) and network security policies.

### Description of the Related Art

Cloud computing platforms have become increasingly popular in providing software, platform, and infrastructure services. For instance, public cloud service providers may provide on-demand network access to compute resources, database storage, content delivery, and other services that may be used by entities. Each of these compute resources is assigned an external IP address (EIP) that the Internet and other computers outside a local network use to identify the compute resource.

The access to these compute resources is generally controlled at the network layer to only allow limited access. For example, certain entities are granted access to certain external IP addresses (EIPs) associated with certain compute resources. When an EIP, a compute resource, and/or a security policy changes, management teams often manually update static files in a git repository.

### BRIEF DESCRIPTION OF DRAWINGS

FIG. 1 depicts a block diagram illustrating functional blocks for a trusted public cloud environment that leverages a widely available public cloud environment, according to one embodiment.

FIG. 2 shows an example trusted public cloud environment (TPCE), in which an automated external network address (ENA) detection and central ENA maintenance and and a network security control system are implemented, according to one embodiment.

FIG. 3 is a block diagram illustrating an example architecture of an ENA detection and maintenance system, according to one embodiment.

FIG. 4 illustrates an example network security control system, according to one embodiment.

FIG. 5 is a flowchart of an example method for automated network security control, according to one embodiment.

FIG. 6 is a block diagram illustrating the architecture of a typical computer system for use in the environment of FIG. 3 according to one embodiment.

The figures depict various embodiments for purposes of illustration only. One skilled in the art will readily recognize from the following discussion that alternative embodiments of the structures and methods illustrated herein may be employed without departing from the principles of the embodiments described herein.

The figures use like reference numerals to identify like elements. A letter after a reference numeral, such as “130a,” indicates that the text refers specifically to the element having that particular reference numeral. A reference numeral in the text without a following letter, such as “130,” refers to any or all of the elements in the figures bearing that reference numeral.

### DETAILED DESCRIPTION

More and more entities, such as enterprises, are migrating to trusted public cloud environments (TPCE) that leverage an available public cloud environment (PCE). Examples of PCEs include, but are not limited to, Amazon Web Services™ (AWS™), Google PCE™ (GCP™), Azure™, etc. Customers of a public cloud environment may be producers offering a variety of services, as well as consumers of these services. In a modern public cloud environment (PCE), many new services/resources may be provisioned with public network addresses, such as external network addresses (ENAs). For example, an ENA may include or be an external IP address (EIP).

Network security controls are the guard rails that help protect large TPCEs. These are primarily applied at network layer to minimize risks by only allowing limited access to specific ENAs. In an existing PCE environment, teams are often required to manually update static files that contain ENAs that need to be used for network configuration, such as allow listing, block listing, etc. Such a manual process requires the involvement of personnel from different departments, and is error-prone. For instance, the public proxy team would create a network address translation (NAT) gateway, and then manually update the NAT ENA in a git repository. Enforcement of these ENAs needs requires another workflow, a pipeline manager, to update the network controls, such as access control lists (ACLs), security group rules, etc. The same problem is also present in the case of restricting access to the Elastic Kubernetes Service (EKS) control plane where a security engineer would update a git repository with new ENAs that are allowed access to the EKS control plane.

Principles described herein solve the above-described problem by providing a service that maintains contextual relationships between network security policies and the specific ENAs and uses these contextual relationships to dynamically update the ACLs whenever there is a change to these ENAs using the relationships. Information related to ENAs is automatically discovered and aggregated. The aggregated information related to ENAs is then used to update network security controls in an automated way. The mapping binds the dynamically discovered ENAs to instances, functional domains, network security policies, and services in a TPCE.

In some embodiments, the mapping is maintained as a declarative specification in the TPCE. In some embodiments, the declarative specification includes a contextual database used to maintain relationships between network information, such as ENA and services in TPCE to build a knowledge base of which ENAs are used in which service, and the network security policies that are enforcing the relationship. The contextual database is continuously updated based on changes to the declarative specification and correlations between changes to ENAs with the relationships to detect and trigger changes to the network security controls. Armed with these mappings, the TPCE can take corrective actions whenever there is a change to the security posture, such as a change to an ENA.

### Overall System Environment

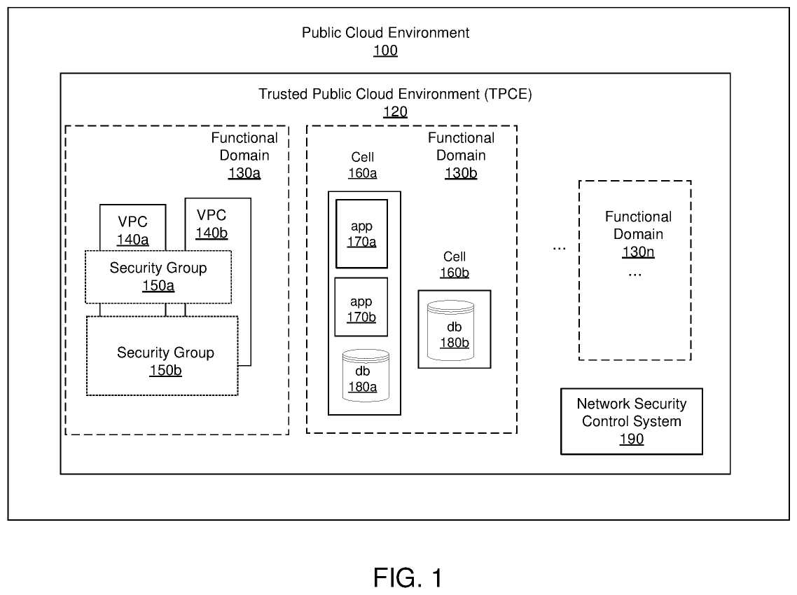

FIG. 1 shows a block diagram illustrating a trusted public cloud environment (TPCE) 120 that leverages an available public cloud environment (PCE) 100, in accordance with one embodiment. Public cloud environments 100 are owned and operated by third-party providers, and the hardware, software, and supporting infrastructure are also owned and managed by the third-party cloud provider. Examples of public cloud environment 100 include, but are not limited to, Amazon Web Services™ (AWS™), Google PCE™ (GCP™), Azure™, etc.

A PCE 100 offers a range of public cloud computing infrastructure services that may be used on demand by a TPCE 120. Examples of public cloud computing infrastructure services include servers, storage, databases, networking, security, load balancing, software, analytics, intelligence, and other infrastructure service functionalities. These infrastructure services may be used by the TPCE 120 to build, deploy, and manage applications in a scalable and secure manner. The TPCE 120 is a trusted public cloud architecture with processing resources, networking resources, storage resources, and other service functionalities with security boundaries that are strictly enforced. An example of a TPCE 120 is a data center with defined and strictly enforced security boundaries.

The TPCE 120 has specific attributes, in accordance with some embodiments. These attributes include attributes required to use available public cloud infrastructure services 110, for example region-specific attributes or environment type-specific attributes. Further attributes support security needs, availability expectations, architectural agility coupled with reliability, developer agility, distributed capabilities, and the ability to perform on multiple available PCEs.

The TPCE 120 may support multiple functional domains 130a, 130b, . . . , 130n. Each functional domain (FD) 130 represents a set of capabilities and features and services offered by one or more computing systems that can be built and delivered independently, in accordance with one embodiment. A functional domain 130 may also be viewed a set of cohesive technical use-case functionalities offered by one or more computing systems. A functional domain 130 has strictly enforced security boundaries. A functional domain 130 defines a scope for modifications. Thus, any modifications to an entity—such as a capability, feature, or service—offered by one or more computing systems within a functional domain 130 may propagate as needed or suitable to entities within the functional domain, but will not propagate to an entity residing outside the bounded definition of the functional domain 130. Although the term functional domain is used herein, the term may be replaced with service group representing a group of services that are specified and configured together in a data center configured in a PCE.

Each functional domain 130 may contain multiple virtual private cloud (VPC) networks, 140a, 140b, . . . , etc. Each virtual private cloud 140 is an on-demand pool of shared resources that are allocated within the functional domain 130 and provide a level of isolation between the users using the resources. Each functional domain 130 may also contain multiple security groups, 150a, 150b, . . . , etc. Each security group 150 represents a declarative model for enforcing network segmentation. Each security group 150 includes entities with similar risk service profiles collected into a single security group with explicit declarative policy brokering connectivity between the groups.

A functional domain 130 may also contain one or more cells, 160, 160b, . . . , etc. A cell 160 represents a collection of services that scale together, and that may be sharded. These services may be applications 170a, 170b, . . . , etc., and/or databases 180a, 180b, . . . , etc.

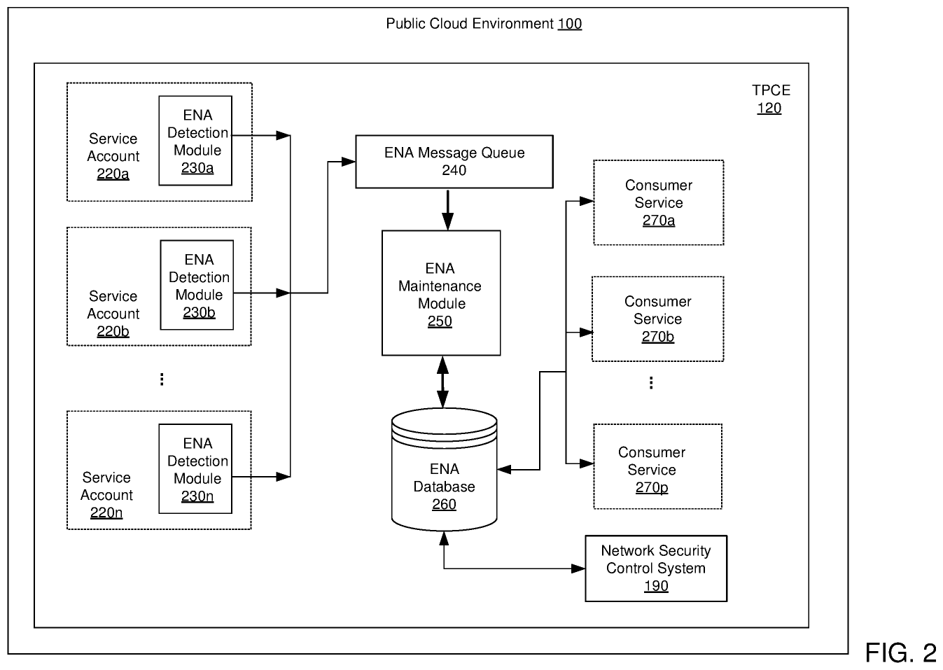

In embodiments described herein, within each functional domain 130, the individual service applications 170a, 170b, . . . , etc., may be each individually monitored by an instance of an ENA detection process (such as described with respect to FIG. 2). The ENA detection process may execute an event-driven process within each service account (not shown) that resides in functional domain 130, where each service account may be associated with one or more executing service applications 170. In some embodiments, the ENA detection process monitors API calls within each individual service account (such as a service account associated with service application 170a) for ENA-related event occurrences.

In some embodiments described herein, the TPCE 120 may also have a central object storage for maintenance of ENA-related data that is gathered by various instances of the ENA detection processes executing with the environment. An ENA maintenance process (such as described in FIG. 2) executing within the TPCE 120 may perform actions that ensure that updated information in association with various ENAs of services executing in the TPCE 120 are stored in the central data storage and available for access by consuming services in the TPCE 120.

The TPCE 120 also includes a network security control system 190 configured to control access to the different functional domains 130a, 130b, and/or resources hosted thereon, such as VPC 140a, 140b, security groups 150a, 150b, cells 160a, 160b, applications 170a 170b, databases 180a, 180b, etc.

### AN EXAMPLE TPCE WITH AN ENA DETECTION AND MAINTENANCE SYSTEM AND A NETWORK SECURITY CONTROL SYSTEM

FIG. 2 depicts an example of a TPCE 120, in which an ENA detection and maintenance system and a network security control system are implemented, in accordance with one embodiment. The TPCE 120 includes an ENA detection module 230, a central ENA maintenance module 250, and the network security control system 190.

A service account 220 may have a service application that is offering a service for use by a consumer. Each service account 220 (220a, 220b . . . 220n) may reside in one or more functional domains (such as functional domain 130 in FIG. 1) of the TPCE 120. Each service application in a service account 220 may be provisioned with an ENA, e.g., an EIP. Each service account 220 may interface with other interacting entities (such as consumer services, etc.) using application programming interfaces (APIs). When a service application in a service account 220 is provisioned with an ENA, the provisioning causes an event to be triggered in association with the API of the service application in the service account 220.

In some embodiments, each API of a service application in a service account 220 is monitored by an ENA detection module 230. Thus, the ENA detection modules 230 are deployed at each of the service accounts, and there may be individual instances of ENA detection modules 230 (i.e., 230a, 230b, . . . , 230n) monitoring corresponding individual APIs of service accounts 220 (i.e., 220a, 220b, . . . , 220n). In some embodiments, the instances of the ENA detection modules 230 executed in individual service accounts leverage native public cloud functionalities. For example, when the PCE 100 is AWS™, an AWS™ lambda function may be implemented within a particular service account as an instance of the ENA detection module 230. As another example, when the PCE 100 is GCP™, Google™ Cloud Functions may be used to implement the ENA detection modules 230.

In some embodiments, responsive to detecting the occurrence of an ENA-related event in a monitored API, the ENA detection module 230 performs one or more lookup actions in association with the triggering ENA-related event, and extracts information in association with the ENA. The extracted information may be, for example, an ENA address value as well as metadata associated with the ENA, such as a service name, an environment in which the service resides, timestamp, etc. The ENA detection module 230 generates a data structure with the ENA address value and the metadata associated with the ENA. Subsequently, the ENA detection module 230 will provide a message with the generated data structure to a message queue service for posting within an ENA message queue 240. The ENA message queue 240 is associated with information regarding external IP addresses of services offered within the TPCE. This information regarding external IP addresses of services offered within the TPCE may be subsequently used for enforcing security and access control policies with respect to the service in the TPCE

In some embodiments, the ENA maintenance module 250 is deployed within a main central location in the TPCE 120. The ENA maintenance process executes in conjunction with the ENA message queue 240 and a central ENA data store 260 that stores information in association with ENAs. The ENA maintenance module 250 monitors the ENA message queue 240 for new messages within the queue 240. When a new message is detected in the ENA message queue 240, the ENA maintenance module 250 processes the detected new message to extract a data structure associated with an ENA of a service offered within the TPCE. The ENA maintenance module 250 processes the extracted data structure and identifies an action to be performed to an entry in an ENA database 260. The ENA maintenance module 250 subsequently updates the entry in the ENA database 260 based on the identified action.

In some embodiments, the ENA database 260 stores data in association with ENAs. Entries in the ENA database may be associated with allocation identifiers, association identifiers, functional domains, and services executing in the TPCE. The entries associated with a service may have entries for the address value of ENA, a name for the service, a functional domain in which the service executes, timestamps, an allocation identifier and an association identifier associated with the service. The entry in the ENA database 260 that is in association with the ENA is updated based on the action that is identified by the ENA maintenance module 250. In some embodiments, the ENA database 260 is a central database that may be securely located within a TPCE 120 that is within any one of the PCEs 100 (e.g., Amazon Web Services™ (AWS™), Google PCE™ (GCP™), Azure™, etc.). The ENA database 260 provides updated information in association with the stored ENAs to any consumer services 270 (e.g., 270a, 270b, . . . , 270n) in the TPCE 120 that may require access to services deployed within the TPCE 120. This provided information may be used for enforcing security and access control policies with respect to the service in the TPCE. In some embodiments, service owners of service applications may be able to view the contents of the ENA database 260, including querying the ENA database 260 about ENAs assigned to a service, and ENAs that have been provisioned and listed against their services. In some embodiments, consumer services that are located outside of the TPCE 120 (e.g., consumer services that are located within a TPCE for a different PCE than PCE 100) may be able to retrieve updated information in association with the stored ENAs in the ENA database 260.

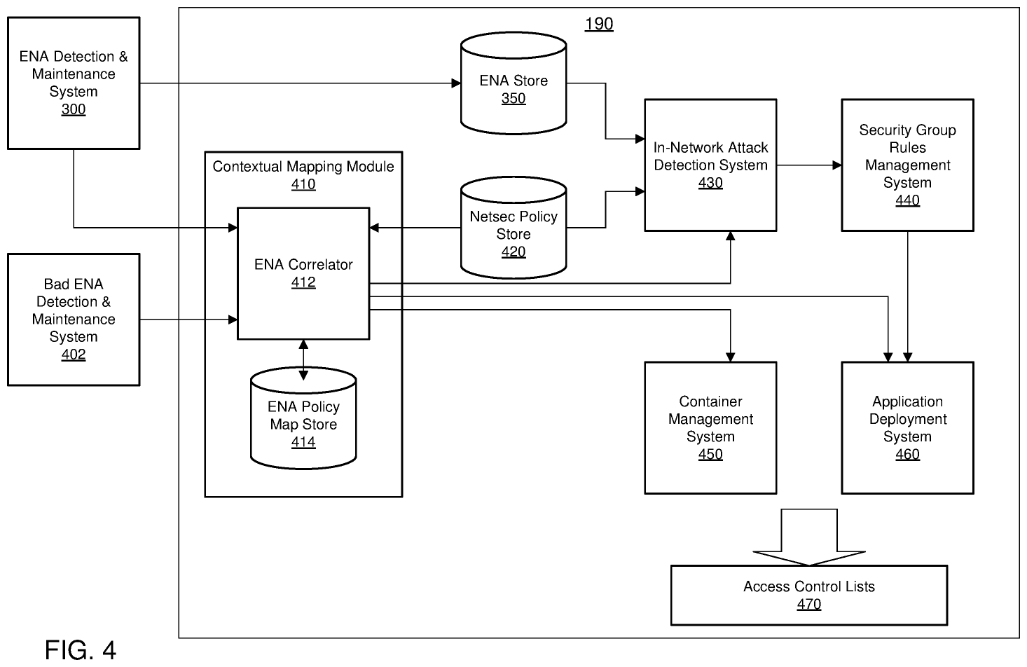

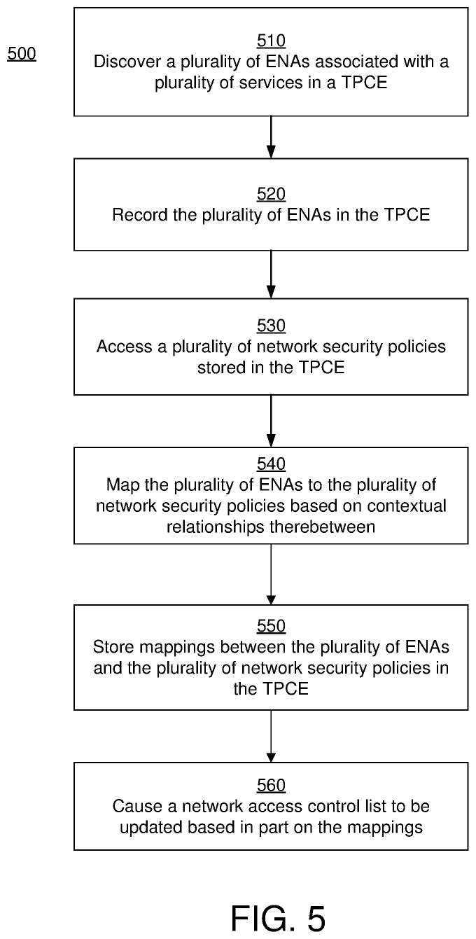

The network security control system 190 is configured to maintain relationships between network security policies and ENAs, and use the relationships to dynamically update the ACLs whenever there is a change to the ENAs. An ACL is a list of rules that specifies which users or systems are granted or denied access to a particular object or system resource. In some embodiments, each system resource has a security attribute that identifies its ACL. The list includes an entry for every user who can access the system. For example, common privileges for a file system's ACL include the ability to read a file or all the files in a directory, to write to the file or files, and to execute the file if it is an executable file or program. ACLs may also be built into network interfaces and the TPCE 120. On the TPCE 120, ACLs are used to prohibit or allow certain types of users to access certain ENAs, which may be associated with different resources or services, e.g., consumer service 270a, 270b, 270p, hosted thereon. Additional details about the network security control system 190 are further discussed below with respect to FIGS. 4 and 5.

### Example Architecture of Ena Detection and Maintenance System

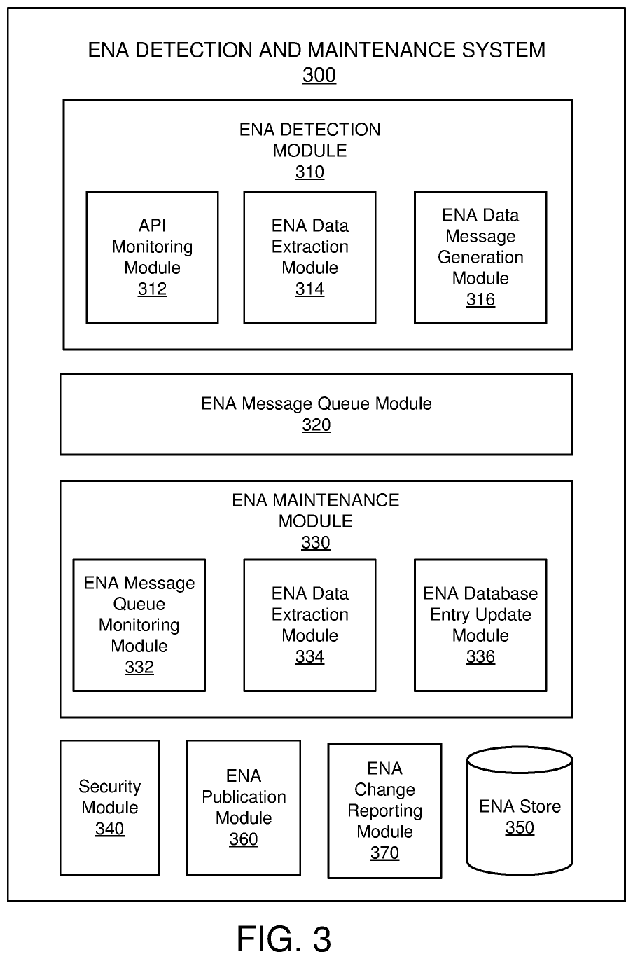

FIG. 3 is a block diagram illustrating an example architecture of an ENA detection and maintenance system 300, according to one embodiment. The ENA detection and maintenance system 300 may be implemented in a TPCE (such as TPCE 120), and/or a PCE (such as PCE 100). When the ENA detection and maintenance system 300 is implemented in TPCE 120, some of its components may correspond to ENA detection module 230, ENA message queue 240, ENA maintenance module 250, and/or ENA database 260 of FIG. 2.

The ENA detection and maintenance system 300 includes an ENA detection module 310, an ENA message queue module 320, an ENA maintenance module 330, a security module 340, a data store 350, an ENA publication module 360, and an ENA change reporting module 370. Alternative configurations of the ENA detection and maintenance system 300 may include different and/or additional modules. Functionality that is indicated as being performed by a particular module may be performed by other modules than those indicated herein. Furthermore, steps of any processes described herein can be performed in an order different from that illustrated herein.

The modules of ENA detection and maintenance system 300 may execute in a TPCE such as a TPCE 120 that resides within a PCE (such as PCE 100 depicted in FIG. 1). The ENA detection module 310 may deploy individual instances of the ENA detection modules 230 to execute within functional domains in conjunction with the security module 330, while the ENA maintenance module 320 may execute in a central location in conjunction with the security module 330 and the data store 350.

In some embodiments, the ENA detection module 310 deploys instances of the ENA detection modules 230 to execute in individual service accounts, such as service accounts 220 in FIG. 2, by leveraging native public cloud functionalities. For example, an AWS™ lambda function or Google™ Cloud Functions may be implemented within a particular service account as an instance of the ENA detection module 310. The term “ENA detection module” is used synonymously with the terms “instance of an ENA detection module,” “ENA detection process” and “instance of an ENA detection process” herein.

In some embodiments, the ENA detection module 310 may include an API monitoring module 312, an ENA data extraction module 314 and an ENA data message generation module 316. Alternative configurations of the ENA detection module 310 may include different and/or additional modules, with functionalities indicated as being performed by a particular module being performed by other modules than those indicated herein. Furthermore, steps of any processes described herein can be performed in an order different from that illustrated herein.

The API monitoring module 312 monitors API calls associated with the service application, and triggers on detecting the occurrence of specific ENA-related events in the monitored API calls. In some embodiments, the triggering events may be API calls that are directed to any of the following events: associate an ENA, disassociate an ENA, create a network address translation (NAT) gateway, delete a NAT gateway, release an ENA, create a virtual private network (VPN) connection, and delete a VPN connection. Other embodiments of the ENA detection module 310 may be configured to trigger on other ENA-related events. In some embodiments, the API monitoring module may also periodically scan all service accounts for any ENA related information that have not been previously reported or that are missed by the API call monitoring.

The ENA data extraction module 314 extracts information regarding a specific ENA and metadata associated with the ENA. When the API monitoring module 312 indicates the occurrence of one of the specific ENA-related events in a monitored API call, the triggering event invokes the ENA data extraction module 314. In some embodiments, the module 314 that is executing in a service account may issue one or more API calls against the PCE, such as PCE 100 depicted in FIG. 1, to obtain ENA related information associated with the triggering event. The ENA related information may include: the ENA address, service application details (such as service name, functional domain in which the service application executes, timestamp, etc.), and the triggering event action details such as: “associate”, “disassociate”, “create NAT gateway”, “delete NAT gateway”, and “release”. In some embodiments, the service application details may be looked up from mandatory tags associated with the PCE 100.

The ENA data message generation module 316 receives the extracted ENA-related information associated with the triggering event. The module 316 packages the extracted ENA-related information into a data format that is appropriate for providing to a message queuing service for posting in a message queue within the TPCE. For each of the identified actions in the triggering event, the ENA data message generation module 316 performs a set of actions. Note that in the actions, the allocation identifier refers to the PCE identifier, while the association identifiers refer to associations between the ENA and the resource that the ENA is associated with. The actions are briefly described below:
When the identified action is “associate” the module 316 extracts the allocation identifier and the association identifier from the message and generates a data structure as described below.
When the identified action is “disassociate” the module 316 extracts the association identifier from the message, and generates a data structure as described below.
When the identified action is “create NAT gateway” the module 316 extracts the allocation identifier and the NAT gateway identifier from the message, and generates a data structure as described below.
When the identified action is “delete NAT gateway” the module 316 extracts the NAT gateway identifier from the message and generates a data structure as described below.
When the identified action is “release” the module 316 extracts the allocation identifier from the message and generates a data structure as described below.

In some embodiments, the ENA data message generation module 316 packages the ENA-specific details into a JSON data structure to adhere to a pre-specified JSON schema for posting to as an ENA message to an ENA message queue. An example of an ENA message as a JSON block including ENA metadata as an ip_metadata sub-block is shown below:

```
{
“name”: “name-dev1-uswest2-abcdef-testingdemo”,
“TPCE_provider”: {
  “region”: “us-west-2”,
  “substrate”: “aws”
  },
  “environment”: “dev1”,
  “public_ips”: {
    “services”: [{
      “service_name”: “testingdemo”,
      “cidr”: [
        “1.2.3.4/32”,
      ],
      “ip_metadata”: [
        { “ip_address”: “1.2.3.4/32”,
          “allocation_id”: “ENA Allocation ID”,
          #<IDs will be linked substrate flag above>
          “association_id”: “ENA Association ID”,
        #<association id will show that IP is in service>
          “timestamp”: “ ”
        },
      ],
      “resource_type”: “natgw”,
      “tags”: [
        { “key”: “key1”,
          “value”: “value1”
        }, {
          “key”: “key2”,
          “value”: “value2”
        }
      ]
    }],
    “functional_domain_name”: “abcdef”,
    “functional_domain_type”: “abcdef”
  },
  “TPCE_instance”: “dev1-uswest2”,
  “grid”: “ ”,
  “ENADetection_And_Maintenance_action”: “add” | “delete”
}
```

The ENA data message generation module 316 connects to the ENA message queue module 320 and provides the ENA message for posting to the ENA message queue. The posted ENA message includes the packaged ENA details in the created JSON data structure such as the example shown above.

In some embodiments, prior to connecting to ENA message queue module 320, the ENA data message generation module 316 may need to acquire pre-specified security-related permissions within the TPCE. In some embodiments, the ENA data message generation module 316 may need to explicitly request permission from the security module 330 for acquiring security-related permissions prior to connecting to the ENA message queue module 320. In some embodiments, the security-related permissions acquired by the module 316 may automatically provide permissions for encrypting the ENA message prior to posting. In some embodiments, the ENA data message generation module 316 may need to acquire explicit permission for encrypting the ENA message. Once the ENA data message generation module 316 acquires the required permissions the security module 330, the module 316 may retrieve encryption related parameters from the data store 350, encrypt the generated ENA message, and then connect to the ENA message queue module 320 for posting the ENA message.

The ENA message queue module 320 manages the ENA message queue (such as the ENA Message Queue 240 depicted in FIG. 2). The module 320 may be located inside a service account that includes the ENA maintenance module 330. In some embodiments, the ENA message queue module 320 may configure the ENA message queue as a FIFO queue. In some embodiments, the contents of the ENA message queue may be encrypted, and access to the contents of the queue may be permitted only to entities with prespecified security clearance levels. The ENA message queue module 320 may receive a request from the ENA data message generation module 316 regarding posting a new ENA message. The module 320 will store the message in the ENA message queue. In some embodiments, the module 320 will send an acknowledgement to the ENA data message generation module 316 to indicate successful posting of the new ENA message in the ENA message queue.

The ENA maintenance module 330 is deployed within a main central location in the TPCE 120. The ENA maintenance module 330 operates in conjunction with the ENA message queue module 320 and a central ENA database 260 (shown in FIG. 2). In some embodiments, the ENA maintenance module 330 is configured by leveraging native public cloud functionalities. For example, an AWS™ lambda function may be configured to execute the functionalities of the deployed ENA maintenance module 330. In some embodiments, the ENA maintenance module 330 may include an ENA message queue monitoring module 332, an ENA data extraction module 334, and an ENA database entry update module 336. Alternative configurations of the ENA maintenance module 330 may include different and/or additional modules, with functionalities indicated as being performed by a particular module being performed by other modules than those indicated herein. Furthermore, steps of any processes described herein can be performed in an order different from that illustrated herein.

The ENA message queue monitoring module 332 monitors the ENA message queue for new messages. The ENA message queue monitoring module 332 is configured to trigger on detecting a new ENA message in the ENA message queue. In some embodiments, upon detecting the new ENA message, the ENA message queue monitoring module 332 may send an indication of the detected new message to the ENA data extraction module 334.

The ENA data extraction module 334 processes a new message in the ENA message queue to extract a data structure that is associated with an ENA of a service offered in the TPCE. The extracted data includes the ENA-related information including: the ENA address, service application details (such as service name, functional domain in which the service application executes, timestamp, etc.), and ENA-related action details such as: “add” (an add operation), “delete” (a delete operation), “associate” (an associate operation), and “disassociate” (a disassociate operation). In some embodiments, the extracted data structure may be a JSON data structure that adheres to a pre-specified JSON schema, such as the JSON block including ENA metadata as an ip_metadata sub-block shown with respect to the ENA data message generation module 316.

The ENA database entry update module 336 processes the extracted data structure to identify the ENA, ENA metadata, and an associated action. The identified action is performed with respect to an entry related to the ENA in a centrally located ENA database (such as the ENA database 260 in FIG. 2). The actions that are identified by the ENA database entry module 336 based on processing the data structure include one of following: “add”, “delete”, “associate”, and “disassociate”. For each of these identified actions, the ENA database entry module 336 performs a set of actions with respect to the corresponding ENA entry in the ENA database. Briefly, the actions may be summarized as follows:
If the functional domain (or any group of services defined for a data center configured on a PCE) containing the service does not exist in as part of the current TPCE entries in the ENA database, it is added
If this service does not exist as part of the current TPCE entries in the ENA database, it is added
If the service exists but there are any new addresses, these new addresses are added
If the service exists but the related ENA addresses have changed (some/all from the current ENA database entry are not in the new details) the old addresses are replaced with the new addresses.

These sets of actions are described in more detail below:

In some embodiments, the ENA database entry update module 336 identifies an “add” action. The extracted information includes the ENA metadata, the functional domain, and the service name. The “add” action is performed to add the service and associated functional domain to the ENA database entry, if it does not already exist. The actions include the following: When the functional domain information does not exist in the ENA database, a new entry for the functional domain is added to the ENA database. An entry for the service and service-related metadata (e.g., ENA address, service name, ENA metadata, etc.) are added in association with the functional domain. When the functional domain has an entry in the ENA database, it is determined if the service name exists in the ENA database under the functional domain. If the name exists, the ENA metadata in the extracted data structure is added to the service's ENA metadata in the entry. If the name does not exist, a new entry is created for the service under the functional domain, and the metadata (e.g., service name, tags, ENA metadata, etc.) are added in the new entry.

In some embodiments, the ENA database entry update module 336 identifies an “delete” action. The extracted information includes the allocation identifier. The “delete” actions performed by the module 336 include the following: When it is determined that the allocation identifier exists for any ENA metadata in the ENA database across all functional domains and services, the ENA metadata entry for the given allocation identifier is deleted. Subsequently, if the service has no ENAs listed in its cidr (classless inter-domain routing) list and no ENA metadata entries, the service entry is removed from the functional domain. Subsequently, if the functional domain does not have any services in it, the entry for the functional domain is deleted from the ENA database. Finally, a clean up function is executed to purge ENAs from the service's CIDR list that do not have a corresponding ENA metadata entry. This clean up action is also executed when it is determined that the allocation identifier in the extracted data structure does not exist for any ENA metadata in the ENA database across all functional domains and services.

In some embodiments, the ENA database entry update module 336 identifies an “associate” action. The extracted information includes an allocation identifier and an association identifier. The “associate” actions performed by the module 336 include the following: the “add” actions described above are executed that adds the functional domain, service to the ENA database if the entry does not already exist. Subsequently the ENA address for the association event is added to the service's cidr list.

In some embodiments, the ENA database entry update module 336 identifies an “disassociate” action. The extracted information includes an association identifier. The “disassociate” actions performed by the module 336 include the following: Based on the association identifier, the ENA metadata entry in the ENA database is searched across all functional domains and services, and the ENA address (referenced in the ENA metadata from the service's CIDR) is deleted.

In some embodiments, when the ENA database entry update module 336 identifies actions such as “create NAT gateway” and “delete NAT gateway” action, these actions are recorded as metadata against the IP address in the ENA database. This ensures that correct removal of the IP addresses from the database when the “disassociate”, “delete”, or “release” events are detected.

In some embodiments, instead of a dedicated ENA database, a centrally located object storage (e.g., an S3 bucket in AWS™) may store an ENA list file. In such embodiments, upon identifying the ENA and the associated action, the ENA database entry update module 336 downloads the ENA list file, and perform the actions mentioned with respect to the ENA database entry instead on the entry corresponding to the ENA in the ENA list. After the actions are completed, the modified ENA list file is saved back in the centrally located object storage.

The security module 340 ensures that only the trusted/authenticated ENA data message generation modules 316 connect to the ENA message queue module 320 for posting a message. The security module may perform explicit authentication of module 316. In some embodiments, the authentication of the module may automatically provide a limited set of permission, such as permission for encrypting the ENA message prior to connecting with the module 320 for posting to the ENA message queue. The security module 340 may also ensure that only a trusted/authenticated ENA database entry update module 336 performs updates to the ENA database or the ENA list files. The security module 340 may also connect back to a service account, such as service account 220 in FIG. 2 to verify any received ENA information.

The data store 350 stores information for the ENA detection and maintenance system 300. The stored data may in association with configuring the various modules of the ENA detection and maintenance system 300 for operational functionalities such as described above. The stored data may also include encryption and decryption parameters as well as data keys associated with posting and accessing ENA messages in the ENA message queue. The data store 350 is a memory, such as a read only memory (ROM), dynamic random-access memory (DRAM), static random-access memory (SRAM), or some combination thereof. In some embodiments, the various modules of the ENA detection and maintenance system 300 may pass various data values directly to each other. In some embodiments, the various modules of the ENA detection and maintenance system 300 may store data values in the data store 350 and retrieve data values as needed from the data store 350.

The ENA publication module 360 publishes the ENAs stored in ENA store 350 to at least some services 270 hosted in the PCE 100, such that the those service 270 have access to the ENA stored in the ENA store 350. The ENA change reporting module 370 is configured to report changes in ENAs to the network security control system 190.

### EXAMPLE ARCHITECTURE OF AUTOMATED NETWORK SECURITY CONTROL SYSTEM

FIG. 4 illustrates an example network security control system 190 according to one embodiment, which may be a part of a TPCE hosted on a PCE, such as (but not limited to) Amazon Web Services™ (AWS™), Google Cloud Platform™ (GCP™), Azure™, etc. The network security control system 190 includes a contextual mapping module 410. The contextual mapping module 410 includes an ENA correlator 412 and an ENA policy map store 414. In embodiments, the ENA correlator 412 has access to ENA store 350 via ENA detection and maintenance system 300. The ENA correlator 412 also has access to the network security policy store 420. The ENA correlator 412 correlates ENAs (stored in the ENA store 350) with network security policies (stored in the network security policy store 420) based on their contextual relationships, and stores the correlated mappings between ENAs and network security policies in the ENA policy map store 414. In some cases, one ENA is mapped to one network security policy. Alternatively, or in addition, multiple ENAs may be mapped to a single network security policy, or a single ENA may be mapped to multiple network security policies. The mappings may be recorded in a database or a data structure, such as a list, or a JSON file.

In some embodiments, each ENA includes a plurality of attributes, and each of the network security policies is associated with a value of an attribute. An ENA having an attribute with the value and a network security policy associated with that value of the attribute are mapped to each other. For instance, an ENA may include one or more of the following attributes: a name of the service associated with the ENA, a functional domain in which the service associated with the ENA executes, a timestamp when the ENA is associated with the service, an allocation identifier associated with an allocation of the ENA, and/or an association identifier associated with an association of the ENA with the service. For example, when a network security policy is associate with a service with a particular name, an ENA associated with a service with that particular name may be mapped to that network security policy. As another example, when a network security policy is associated with a particular functional domain, an ENA or multiple ENAs associated with the particular functional domain are mapped to the network security policy.

In some embodiments, the ENA correlator 412 receives new ENAs or changes of ENAs detected by the ENA detection and maintenance system 300. Responsive to receiving a new ENA or an update of an existing ENA, the ENA correlator 412 correlates the new ENA or the updated ENA with a network security policy, and updates the mappings in the store 414. For example, when a new ENA is associated with an existing service, the existing service is associated with an existing network security policy, a new mapping is generated to associate the new ENA with the existing network security policy, and the new mapping is stored in the ENA policy map store 414.

In some embodiments, there is also a bad ENA detection and maintenance system 402 configured to detect bad ENAs that should be blocked from access, and maintains a list of bad ENAs. The ENA correlator 412 also has access to the bad ENA detection and maintenance system 402 and correlates the bad ENAs with related network security policies.

Responsive to generating a new or updated mapping, the ENA correlator 412 causes a network access control list 470 on the TPCE to be updated or generated accordingly. The network access control list 470 includes a list of rules that specifies which entities are granted or denied access to the plurality of ENAs associated with the plurality of services. For example, a mapping may indicate that a particular type of entities are allowed to access a particular service associated with a particular ENA. The network access control list 470 may add a new rule specifying that a list of entities that belong to the type are allowed to access the particular ENA. As another example, an existing rule specifies that a list of entities are allowed to access an ENA, which was previously associated with a particular service. An updated mapping indicates that a new ENA is associated with the particular service now. The existing rule may be updated to specify that the list of entities are allowed to access the new ENA.

In some embodiments, the network security control system 190 includes an in-network attack detection system 430, a container management system 450, and/or an application deployment system 460. Each of these systems 430, 450, 460 may have its own access control list 470. In some embodiments, responsive to generating a new mapping or updating an existing mapping between an ENA and a network security policy, the ENA correlator 412 sends the new or updated mapping to the in-network attack detection system 430, container management system 450, and/or application deployment system 460, causing the corresponding system to update its access control lists 470.

In some embodiments, the network security control system 190 also includes a security group rules management system 440 configured to receive information from the in-network attack detection system 430, and update security group rules based on the information received from the in-network attack detection system 430. The updated security group rules are then sent to the application deployment system 460, causing the application deployment system 460 to update its access control list 470.

In some embodiments, the network security control system 190 is also configured to detect changes in the network security policy store. Responsive to detecting a network security policy is changed, the network security control system 190 may also update the mappings in the ENA policy map store 414.

### Example Dynamic Network Security Control Process

FIG. 5 is a flowchart of an example method 500 for automated network security control, according to one embodiment. In various embodiments, the method includes different or additional steps than those described in conjunction with FIG. 5. Further, in some embodiments, the steps of the method may be performed in different orders than the order described in conjunction with FIG. 5. The method described in conjunction with FIG. 5 may be carried out by the network security control system 190 in various embodiments, while in other embodiments, the steps of the method are performed by any other modules or systems in the TPCE 120.

The network security control system 190 discovers 510 a plurality of ENAs associated with a plurality of services in the TPCE 120. The network security control system 190 records 520 the plurality of ENAs in the TPCE 120, e.g., ENA store 350. In some embodiments, the ENAs are external IP addresses (EIPs). An EIP is used across Internet in locating networked computing resources or services, such as computer systems, devices, and servers. Each service on the TPCE 120 is associated with an EIP or ENA, via which entities can access such a service. Each ENA includes a plurality of attributes, and a subset or all of these attributes values are also recorded in the first storage relationally with the ENAs. For example, the these attributes may include (but not limited to) a network address value of the ENA, a name of the service associated with ENA, a functional domain in which the service associated with the ENA executes, a time stamp when the ENA is associated with the service, an allocation identifier associated with an allocation of the ENA, and/or an association identifier associated with an association of the ENA with the service.

The network security control system 190 accesses 530 a plurality of network security policies stored in the TPCE 120, e.g., network security policy store 420. Network security policies specify what type of (or which) entities are allowed to access what type of (or which) services on the TPCE 120.

The network security control system 190 maps 540 the plurality of ENAs to the plurality of network security policies based on contextual relationships therebetween. In some embodiments, mapping the plurality of ENAs to the plurality of network security policies is based on values of particular attributes of ENAs. In some embodiments, the network security control system 190 identifies a value of an attribute associated with a particular ENA, identifies a particular network security policy associated with the value of the attribute, and maps the particular ENA to the particular network security policy. For example, the network security control system 190 identifies a name of a service associated with a particular ENA, identifies a particular network security policy associated with the name of the service, and maps the particular ENA to the particular network security policy. As another example, the network security control system 190 identifies a functional domain of a service associated with a particular ENA, identifies a particular network security policy associated with the functional domain of the service, and maps the particular ENA to the particular network security policy.

The network security control system 190 stores 550 mappings between the plurality of ENAs and the plurality of network security policies in the TPCE 120, e.g., ENA policy map store 414. The network security control system 190 causes 560 a network access control list (e.g., network access control list 470) to be updated based in part on the mappings. The network access control list includes a list of rules that specifies which entities are granted or denied access to the plurality of ENAs associated with the plurality of services. For example, a mapping may indicate that a particular type of entities are allowed to access a particular service associated with a particular ENA. The network access control list 470 may add a new rule specifying that a list of entities that belong to the type are allowed to access the particular ENA. As another example, an existing rule specifies that a list of entities are allowed to access an ENA, which was previously associated with a particular service. An updated mapping indicates that a new ENA is associated with the particular service now. The existing rule may be updated to specify that the list of entities are allowed to access the new ENA.

Notably, the TPCE 120 may change as time goes on. The plurality of ENAs and the network security policies change as the TPCE 120 changes. Such changes may include (but are not limited to) a creation of a new service associated with a new ENA in the TPCE, an association of a new ENA with an existing service in the TPCE, a deletion of an existing service associated with an existing ENA in the TPCE, a disassociation of an existing ENA from an existing service in the TPCE, a creation of a network address transation (NAT) gateway associated with an ENA in the TPCE, a deletion of a NAT gateway associated with an existing ENA in the TPCE, a release of an ENA in the TPCE, a creation of a virtual private network (VPN) connection in the TPCE, and/or a deletion of a VPN connection in the TPCE.

The network security system 190 is configured to dynamically detect changes in the ENAs and/or network security policies, and automatically update the mapping based in part on the changed ENAs and/network security policies, which, in turn, cause the network access control list to dynamically changed. As such, the automated network security system 190 described herein improves the network security and reduces errors in TPCEs, improving user experience.

### Computer Architecture

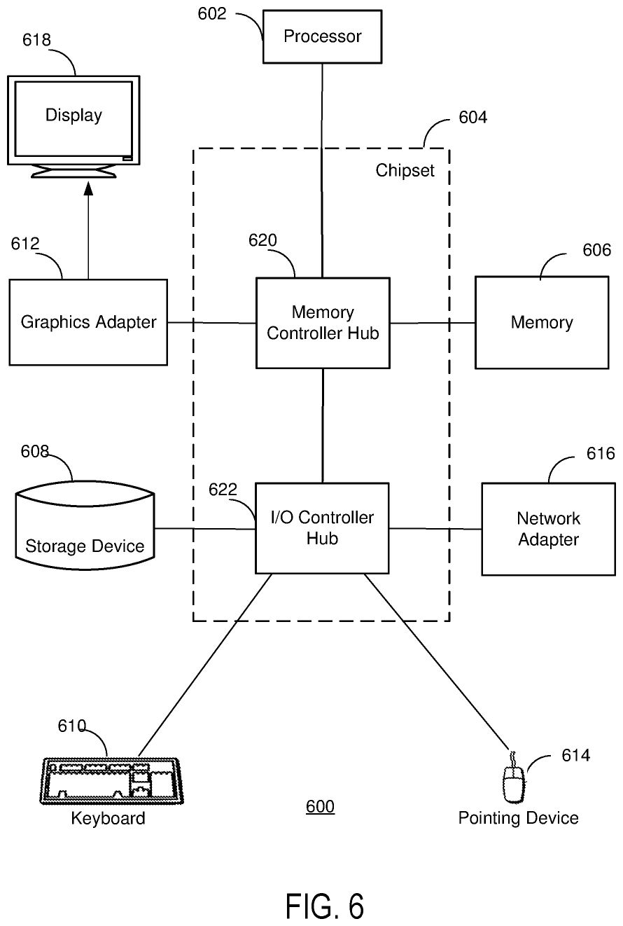

FIG. 6 is a block diagram illustrating the architecture of a typical computer system 600 for use in the environments of FIG. 3 according to one embodiment. Illustrated are at least one processor 602 coupled to a chipset 604. Also coupled to the chipset 604 are a memory 606, a storage device 608, a keyboard 610, a graphics adapter 612, a pointing device 614, and a network adapter 616. A display 618 is coupled to the graphics adapter 612. In one embodiment, the functionality of the chipset 604 is provided by a memory controller hub 620 and an I/O controller hub 622. In another embodiment, the memory 606 is coupled directly to the processor 602 instead of the chipset 604.

The storage device 608 is a non-transitory computer-readable storage medium, such as a hard drive, compact disk read-only memory (CD-ROM), DVD, or a solid-state memory device. The memory 606 holds instructions and data used by the processor 602. The pointing device 614 may be a mouse, track ball, or other type of pointing device, and is used in combination with the keyboard 610 to input data into the computer system 600. The graphics adapter 612 displays images and other information on the display 618. The network adapter 616 couples the computer system 600 to a network.

As is known in the art, a computer system 600 can have different and/or other components than those shown in FIG. 6. In addition, the computer system 600 can lack certain illustrated components. For example, a computer system 600 acting as an online system 300 may lack a keyboard 610 and a pointing device 614. Moreover, the storage device 608 can be local and/or remote from the computer system 600 (such as embodied within a storage area network (SAN)).

The computer system 600 is adapted to execute computer modules for providing the functionality described herein. As used herein, the term “module” refers to computer program instruction and other logic for providing a specified functionality. A module can be implemented in hardware, firmware, and/or software. A module can include one or more processes, and/or be provided by only part of a process. A module is typically stored on the storage device 608, loaded into the memory 606, and executed by the processor 602.

The types of computer systems 600 used by the system of FIG. 3 can vary depending upon the embodiment and the processing power used by the entity. For example, a client device may be a mobile phone with limited processing power, a small display 618, and may lack a pointing device 614. The online system 300 in contrast, may comprise multiple blade servers working together to provide the functionality described herein.

### Additional Considerations

The particular naming of the components, capitalization of terms, the attributes, data structures, or any other programming or structural aspect is not mandatory or significant, and the mechanisms that implement the embodiments described may have different names, formats, or protocols. Further, the systems may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain embodiments described herein include process steps and instructions described in the form of an algorithm. It should be noted that the process steps and instructions of the embodiments could be embodied in software, firmware or hardware, and when embodied in software, could be downloaded to reside on and be operated from different platforms used by real-time network operating systems.

The embodiments described also relate to apparatuses for performing the operations herein. An apparatus may be specially constructed for the required purposes, or it may comprise a general-purpose computer selectively activated or reconfigured by a computer program stored on a computer readable medium that can be accessed by the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, the present embodiments are not described with reference to any particular programming language. It is appreciated that a variety of programming languages may be used to implement the teachings of the embodiments as described herein.

The embodiments are well suited for a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes and may not have been selected to delineate or circumscribe the inventive subject matter. Accordingly, the disclosure of the embodiments is intended to be illustrative, but not limiting.

We claim:

1. A computer-implemented method for dynamic network security control, the method comprising:
discovering a plurality of external network addresses (ENAs) associated with a plurality of services in a trusted public cloud environment (TPCE);
recording the plurality of ENAs in the TPCE;
accessing a plurality of network security policies stored in the TPCE;
mapping the plurality of ENAs to the plurality of network security policies based on contextual relationships therebetween;
storing mappings between the plurality of ENAs and the plurality of network security policies in the TPCE; and
causing a network access control list to be updated based in part on the mappings between the plurality of ENAs and the plurality of network security policies, the network access control list containing a list of rules that specifies which entities are granted or denied access to the plurality of ENAs associated with the plurality of services.

2. The computer-implemented method of claim 1, the method further comprising:
enforcing the network access control list by:
receiving a request from an entity for access a particular service of the plurality of services;
retrieving a rule on the list of rules that specifies which entities are granted or denied access to a particular ENA associated with the particular service; and
granting or denying the request based in part on the rule.

3. The computer-implemented method of claim 1, further comprising:
detecting a change in the plurality of ENAs; and
responsive to detecting a change in the plurality of ENAs,
updating the mappings between the changed plurality of ENAs and the plurality of network security policies stored in a third storage; and
causing the network access control list to be updated based on the updated mappings.

4. The computer-implemented method of claim 3, detecting the change in the plurality of ENAs comprising detecting at least one of:
a creation of a new service associated with a new ENA in the TPCE;
an association of a new ENA with an existing service in the TPCE;
a deletion of an existing service associated with an existing ENA in the TPCE;
a disassociation of an existing ENA from an existing service in the TPCE;
a creation of a network address translation (NAT) gateway associated with an ENA in the TPCE;
a deletion of an NAT gateway associated with an existing ENA in the TPCE;
a release of an ENA in the TPCE;
a creation of a virtual private network (VPN) connection in the TPCE; and
a deletion of a VPN connection in the TPCE.

5. The computer-implemented method of claim 1, wherein recording the plurality of ENAs includes for each ENA in the plurality of ENAs, recording one or more of the following attributes associated with the ENA:
a network address value of the ENA;
a name of a service associated with the ENA;
a functional domain in which the service associated with the ENA executes;
a time stamp when the ENA is associated with the service;
an allocation identifier associated with an allocation of the ENA; or
an association identifier associated with an association of the ENA with the service.

6. The computer-implemented method of claim 5, wherein mapping the plurality of ENAs to the plurality of network security policies based on contextual relationships therebetween comprises:
identifying a value of an attribute associated with a particular ENA;
identifying a particular network security policy associated with the value of the attribute; and
mapping the particular ENA to the particular network security policy.

7. The computer-implemented method of claim 6, wherein mapping the plurality of ENAs to the plurality of network security policies based on contextual relationships therebetween comprises:
identifying a name of a service associated with a particular ENA;
identifying a particular network security policy associated with the name of the service; and
mapping the particular ENA to the particular network security policy.

8. The computer-implemented method of claim 6, wherein mapping the plurality of ENAs to the plurality of network security policies based on contextual relationships therebetween comprises:
identifying a functional domain of a service associated with a particular ENA;
identifying a particular network security policy associated with the functional domain of the service; and
mapping the particular ENA to the particular network security policy.

9. The computer-implemented method of claim 1, further comprising:
detecting a change in the plurality of network security policies; and
responsive to detecting a change in the plurality of network security policies,
updating the mappings between the plurality of ENAs and the changed plurality of network security policies stored in a third storage; and
causing the network access control list to be updated based on the updated mappings.

10. A non-transitory computer-readable medium, stored thereon computer-executable instructions, that when executed by a processor of a computer system, cause the computer system to:
discover a plurality of external network addresses (ENAs) associated with a plurality of services in a trusted public cloud environment (TPCE);
record the plurality of ENAs in the TPCE;
access a plurality of network security policies stored in the TPCE;
map the plurality of ENAs to the plurality of network security policies based on contextual relationships therebetween;
store mappings between the plurality of ENAs and the plurality of network security policies in the TPCE; and
cause a network access control list to be updated based in part on the mappings between the plurality of ENAs and the plurality of network security policies, the network access control list containing a list of rules that specifies which entities are granted or denied access to the plurality of ENAs associated with the plurality of services.

11. The non-transitory computer-readable medium of claim 10, stored thereon additional computer-executable instructions, that when executed by a processor of a computer system, cause the computer system to:
enforce the network access control list by:
receiving a request from an entity for access a particular service of the plurality of services;
retrieving a rule on the list of rules that specifies which entities are granted or denied access to a particular ENA associated with the particular service; and
granting or denying the request based in part on the rule.

12. The non-transitory computer-readable medium of claim 10, stored thereon additional computer-executable instructions, that when executed by a processor of a computer system, cause the computer system to:
detect a change in the plurality of ENAs; and
responsive to detecting a change in the plurality of ENAs,
update the mappings between the changed plurality of ENAs and the plurality of network security policies stored in a third storage; and
cause the network access control list to be updated based on the updated mappings.

13. The non-transitory computer-readable medium of claim 12, detecting the change in the plurality of ENAs comprising detecting at least one of:
a creation of a new service associated with a new ENA in the TPCE;
an association of a new ENA with an existing service in the TPCE;
a deletion of an existing service associated with an existing ENA in the TPCE;
a disassociation of an existing ENA from an existing service in the TPCE;
a creation of a network address translation (NAT) gateway associated with an ENA in the TPCE;
a deletion of an NAT gateway associated with an existing ENA in the TPCE;
a release of an ENA in the TPCE;
a creation of a virtual private network (VPN) connection in the TPCE; and
a deletion of a VPN connection in the TPCE.

14. The non-transitory computer-readable medium of claim 10, wherein recording the plurality of ENAs includes for each ENA in the plurality of ENAs, recording one or more of the following attributes associated with the ENA:
a network address value of the ENA;
a name of the service associated with the ENA;
a functional domain in which the service associated with the ENA executes;
a time stamp when the ENA is associated with the service;
an allocation identifier associated with an allocation of the ENA; or
an association identifier associated with an association of the ENA with the service.

15. The non-transitory computer-readable medium of claim 14, wherein mapping the plurality of ENAs to the plurality of network security policies based on contextual relationships therebetween comprises:
identifying a value of an attribute associated with a particular ENA;
identifying a particular network security policy associated with the value of the attribute; and
mapping the particular ENA to the particular network security policy.

16. The non-transitory computer-readable medium of claim 15, wherein mapping the plurality of ENAs to the plurality of network security policies based on contextual relationships therebetween comprises:
identifying a name of the service associated with a particular ENA;
identifying a particular network security policy associated with the name of the service; and
mapping the particular ENA to the particular network security policy.

17. The non-transitory computer-readable medium of claim 15, wherein mapping the plurality of ENAs to the plurality of network security policies based on contextual relationships therebetween comprises:
identifying a functional domain of the service associated with a particular ENA;
identifying a particular network security policy associated with the functional domain of the service; and
mapping the particular ENA to the particular network security policy.

18. The non-transitory computer-readable medium of claim 10, stored thereon additional computer-executable instructions, that when executed by a processor of a computer system, cause the computer system to:
detect a change in the plurality of network security policies; and
responsive to detecting a change in the plurality of network security policies,
update the mappings between the plurality of ENAs and the changed plurality of network security policies stored in a third storage; and
cause the network access control list to be updated based on the updated mappings.

19. A computer system comprising:
a processor; and
a non-transitory computer readable storage medium, stored thereon computer-executable instructions, that when executed by the processor, cause the processor to:
discover a plurality of external network addresses (ENAs) associated with a plurality of services in a trusted public cloud environment (TPCE);
record the plurality of ENAs in the TPCE;
access a plurality of network security policies stored in the TPCE;
map the plurality of ENAs to the plurality of network security policies based on contextual relationships therebetween;
store mappings between the plurality of ENAs and the plurality of network security policies in the TPCE; and
cause a network access control list to be updated based in part on the mappings between the plurality of ENAs and the plurality of network security policies, the network access control list containing a list of rules that specifies which entities are granted or denied access to the plurality of ENAs associated with the plurality of services.
